(19) United States
(12) Patent Application Publication
(10) Pub. No.: US 2026/0025857 A1
(43) Pub. Date: Jan. 22, 2026

(54) PHYSICAL DOWNLINK CONTROL CHANNEL (PDCCH) ORDER BASED ADAPTATION OF RANDOM ACCESS CHANNEL (RACH) CONFIGURATION

(71) Applicant: Qualcomm Incorporated, San Diego, CA (US)

(72) Inventors: Ahmed Attia ABOTABL, San Diego, CA (US); Krishna Kiran MUKKAVILLI, San Diego, CA (US); Muhammad Sayed Khairy ABDELGHAFFAR, San Jose, CA (US)

(21) Appl. No.: 18/775,786

(22) Filed: Jul. 17, 2024

(51) Int. Cl. H04W 74/0838; H04W 72/23

(52) U.S. Cl. CPC H04W 74/0838; H04W 72/23

(57) ABSTRACT

Certain aspects of the present disclosure provide techniques for random access channel (RACH) configuration. A method for wireless communications by an apparatus comprising: transmitting an indication of a random access channel (RACH) configuration indicating one or more RACH occasions (ROs); transmitting a physical downlink control channel (PDCCH) order comprising a first indication, wherein the first indication indicates activation of an adaptation of the RACH configuration, wherein the adaptation of the RACH configuration adapts the RACH configuration to further indicate one or more additional ROs; and monitoring the one or more ROs and the one or more additional ROs

### FIELD OF THE DISCLOSURE

Aspects of the present disclosure relate to wireless communications, and more particularly, to techniques for random access channel (RACH) configuration.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by an apparatus. The method includes transmitting an indication of a random access channel (RACH) configuration indicating one or more RACH occasions (ROs); transmitting a physical downlink control channel (PDCCH) order comprising a first indication, wherein the first indication indicates activation of an adaptation of the RACH configuration, wherein the adaptation of the RACH configuration adapts the RACH configuration to further indicate one or more additional ROs; and monitoring the one or more ROs and the one or more additional ROs.

Another aspect provides a method for wireless communication by an apparatus. The method includes receiving an indication of a RACH configuration indicating one or more ROs; receiving a PDCCH order comprising a first indication, wherein the first indication indicates activation of an adaptation of the RACH configuration, wherein the adaptation of the RACH configuration adapts the RACH configuration to further indicate one or more additional ROs; and transmitting a confirmation signal corresponding to the PDCCH order during one of the one or more additional ROs.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts two illustrative timeframes comprising one or more random access channel (RACH) occasions (ROs) and one or more additional ROs activated based on an indication provided in a physical downlink control channel (PDCCH) order to adapt the RACH configuration.

FIG. 6 depicts a process flow of communications between a network entity and a UE related to the network entity providing an indication to adapt the RACH configuration to include one or more additional ROs.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for physical downlink control channel (PDCCH) order based adaptation to a random access channel (RACH) configuration.

The development of network energy saving techniques continues to be a focus for network hardware providers and operators. For example, the use of many antennas transmitting and receiving at high power has fueled the interest for network energy saving techniques. Many studies focus on network energy savings techniques in the time domain, frequency domain, spatial domain, and power domain to reduce energy from the network side.

There are at least two general ways to save energy on the network side. One way is to reduce the number of transmissions and/or receptions. The other way includes managing the clustering of transmissions or receptions such that the network entity may enter and remain in one or more sleep states to reduce energy consumption. For example, a network entity may save energy by clustering periods of active communications together such that there are subsequent periods of no communication that enable the network entity to enter one or more different sleep states. In certain aspects, three sleep states are considered: a micro sleep state, a light sleep state, and a deep sleep state. Micro sleep state, light sleep state, and deep sleep state refer to different incremental levels of pauses to operation of a device. Each sleep state may be differentiated by which hardware elements of the device are powered down to a lower level or powered off. For example, in the deep sleep state, the power amplifier and the baseband processor may be turned off, while in the light sleep state the power amplifier may not be turned off. Additionally, in the micro sleep state, for example, hardware elements other than the power amplifier and the baseband processor may be powered down or turned off. In some aspects, in the micro sleep state certain processes may be temporarily paused thus reducing the load on one or more of the processors and in turn the energy usage. The aforementioned energy savings considerations corresponding to the micro sleep state, light sleep state, and deep sleep state are merely exemplary. In general, there may be one or more different sleep states that a device may be configured to operate in to reduce energy consumption. It is further noted that each of the different sleep states may take different amounts of time to enter and exit. Thus, it may not be advantageous to enter a deep sleep state when a period available to sleep is shorter than the time it takes to enter and exit the sleep state. Accordingly, there is a tradeoff between the amount of time to enter and exit a sleep state and the amount of energy that can be saved while the network entity operates in the sleep state. Thus, when there are periods of no communication that are equal to or greater than the time it takes to enter and exit a sleep state, the network entity may utilize the corresponding sleep state to save energy. In certain aspects, it may be advantageous to cluster communications so that more light sleep states or deep sleep states may be utilized than micro sleep states so more energy may be saved with respect to each unit of time spent in a sleep state. For example, a network entity may enter and exit a micro sleep state faster than the light sleep state and the deep sleep state. However, a network entity operating in a deep sleep state saves more energy than when it is operating in a micro sleep state or a light sleep state. Therefore, in certain aspects it may be more advantageous to cluster communications in a way that a deep sleep state may be achieved as opposed to a number of micro sleep states or light sleep states for the same duration of time.

As a result, networks may implement techniques such as reducing the number of RACH occasions (ROs) that a network monitors over a given timeframe. An RO is a time-frequency resource that is available for the communication of a RACH preamble (e.g., from a UE to a network entity) that is part of the RACH process for establishing initial connection between a UE and network entity and/or configuring or updating a timing advance (TA) for ongoing communications between the UE and network entity. The occurrence of one or more ROs within a timeframe, along with other parameters such as what subframes of the timeframe are configured with ROs, for example, are specified by random access configurations. The random access configurations may comprise a table of configurations specified by a technical standard and denoted by a RACH configuration index. In LTE, there is only one RACH occasion specified by RRC message (SIB2) for all the possible RACH preambles, but 5G (NR) is more complicated. In NR, the sync signal (SSB) is associated with different beams and a UE selects a certain beam and sends a PRACH (e.g., including the RACH preamble) using that beam during the nearest RACH occasion, which may occur every 10, 20, 40, 80, 160 ms. Networks may adjust a periodicity at which ROs occur, such as instead of ROs being spaced every 20 ms or 40 ms, ROs may be spaced more sparsely apart, for example, every 80 ms or 160 ms. A configuration with ROs spaced more sparsely apart results in fewer number of ROs in a given timeframe. Optionally, the fewer number of ROs in the given timeframe may be clustered together, for example, each occurring within a first quarter or half of a timeframe as opposed to spatially allocated throughout the timeframe. The advantage to the aforementioned techniques is that the network entity may enter a sleep state that is deeper than the micro sleep state (e.g., the light sleep state or the deep sleep state) thereby enabling the network entity a greater energy saving opportunity. In particular, because the overhead percentage from exiting and entering the sleep state is reduced, the UE spends more time in a sleep state, thereby justifying the deeper sleep state. The aforementioned RACH configuration with fewer ROs may be referred to as a sparse RACH configuration, as compared to a RACH configuration with a greater number of ROs, which may be referred to as a dense RACH configuration.

However, while sparse RACH configurations can provide energy savings to a network entity, there are operational challenges introduced when there are fewer ROs and/or the ROs are clustered into a segment of a timeframe. For example, a network entity may detect that a UE is out of time synchronization. In such an instance, the network entity may request a random access procedure using a PDCCH order. In response to the PDCCH order, the UE responds during the next RO with a random access preamble that the network entity can use to adjust the time synchronization of the UE with the network entity, such as adjust a timing advance. However, since the network entity and UE are operating under a sparse RACH configuration, the next RO may not be for some time in the future. The delay introduced in responding can lead to increased latency and the potential for collision with another device attempting to communicate with the network entity during the same next RO.

Accordingly, certain aspects herein provide a technical solution by providing techniques for the PDCCH order to activate an adaption of the RACH configuration to indicate one or more additional ROs that the network will monitor in addition to the one or more ROs configured under the RACH configuration, which may be a sparse RACH configuration. Some technical advantages the techniques provide include, for example and without limitation, a reduction in latency and reduction in likelihood of a collision since there are one or more new ROs available. Additionally, since the network entity may dynamically implement additional ROs when needed, energy savings provided through the implementation of the sparse RACH configuration can be obtained during intervals of time that do not require the network entity to activate one or more additional ROs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

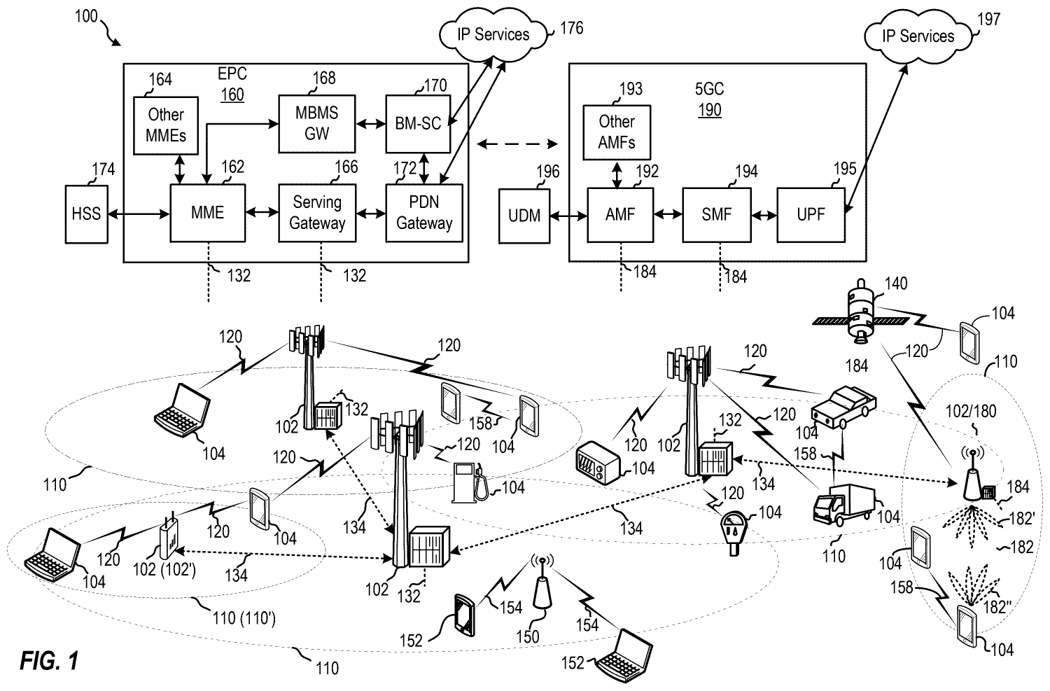

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

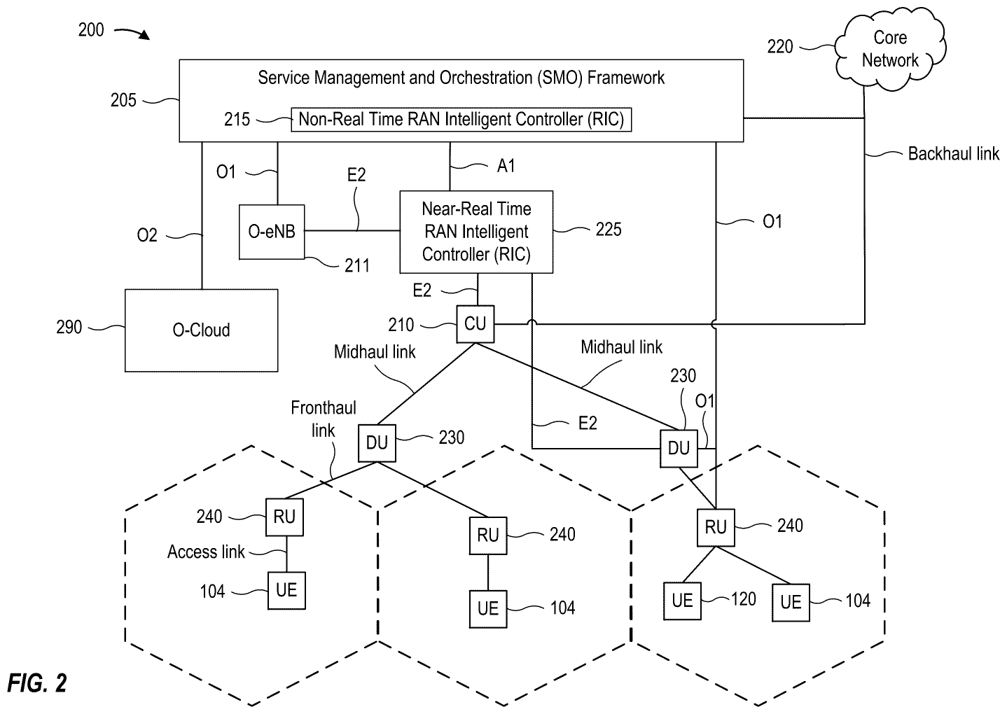

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

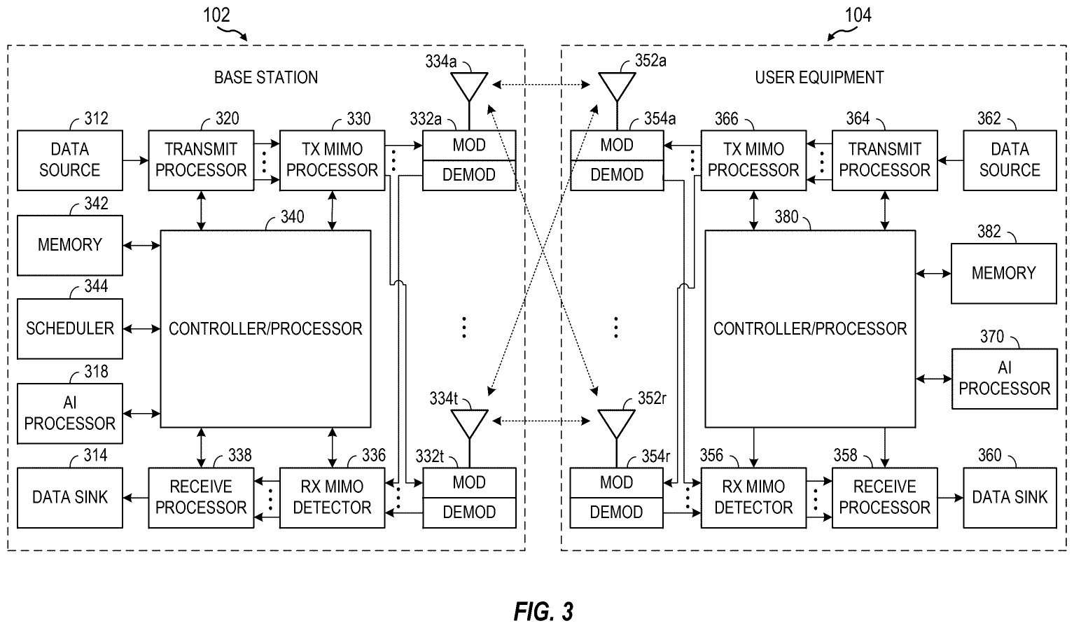

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCA), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

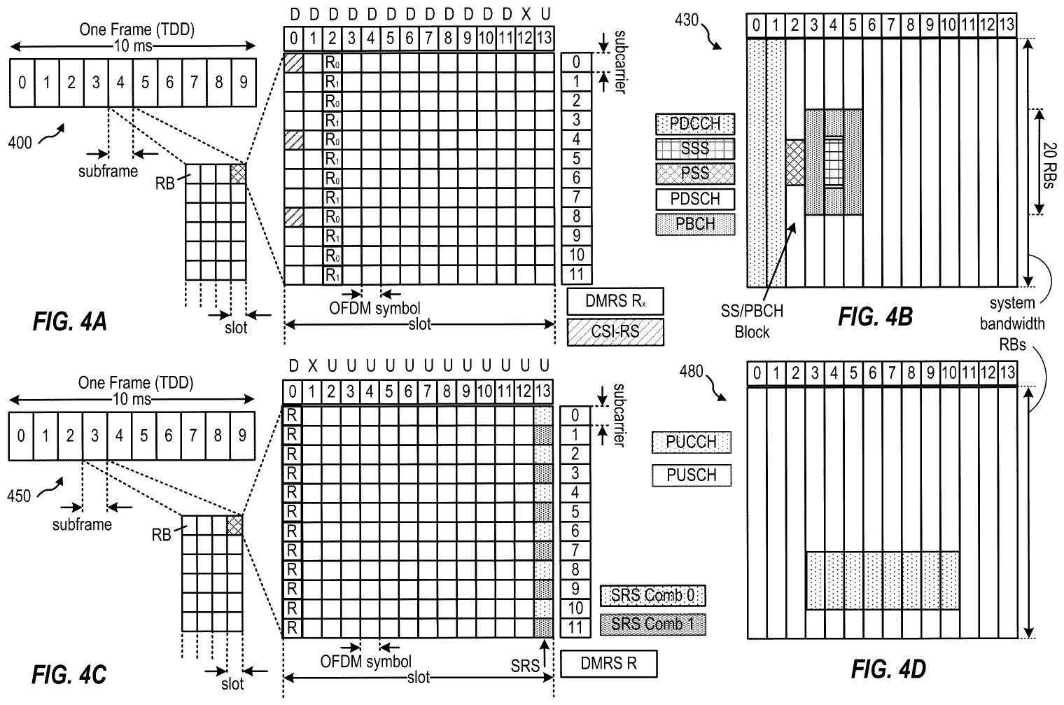

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to PDCCH Ordered Adaptation to a RACH Configuration

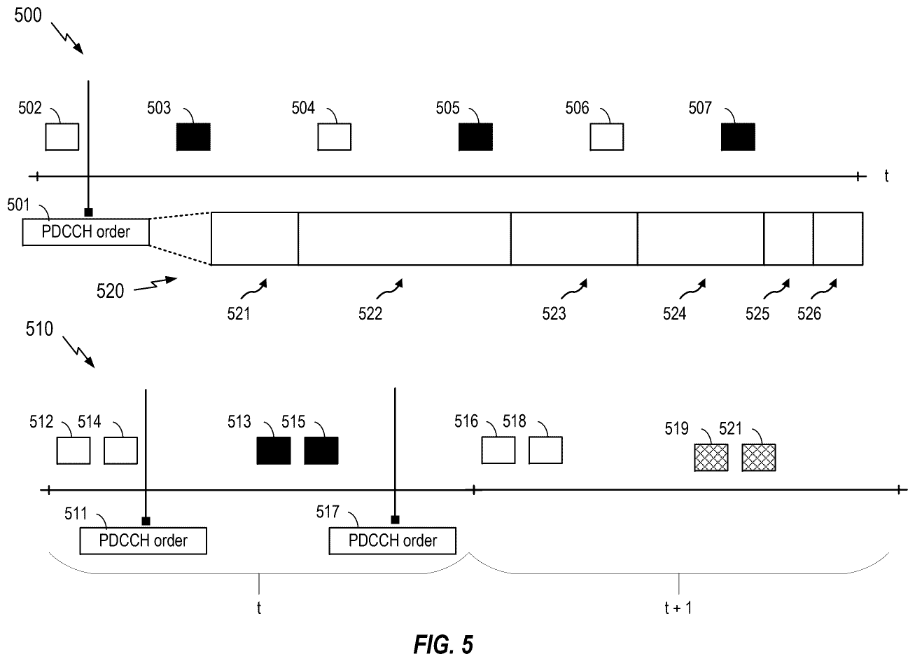

FIG. 5 depicts two illustrative timeframes comprising one or more ROs and one or more additional ROs activated based on an indication provided in a PDCCH order to adapt the RACH configuration. The illustrated empty squares depict the one or more ROs 502, 504, 506 depicted in a first illustrative timeframe 500 that may be specified by a first RACH configuration, for example a first sparse RACH configuration. The illustrated solid squares depict the one or more additional ROs 503, 505, 507 depicted in the first illustrative timeframe 500 that are activated based on the network entity transmitting a PDCCH order 501 having a first indication that indicates activation of an adaptation to the first RACH configuration, for example an adaptation of the first sparse RACH configuration.

The second illustrative timeframe 510 includes two periods, a first period t and a second period t+1. The second illustrative timeframe 510 is an example of RACH periods (e.g., the first period and second period) repeating into the future. The one or more ROs 512, 514 in the first period t, which repeat in the second period t+1 as the one or more ROs 516, 518, may be specified by a second RACH configuration, for example a second sparse RACH configuration. The one or more additional ROs 513 and 515 depicted in the second illustrative timeframe 510 may be activated based on the network entity transmitting a PDCCH order 511 having a first indication that indicates activation of an adaptation to the second RACH configuration, for example an adaptation of the second sparse RACH configuration.

In general, a RACH configuration refers to the random access configuration which may be specified by a technical standard (e.g., 3GPP Release 15) and denoted by a RACH configuration index. Each RACH configuration includes a plurality of parameters, for example, including but not limited to the number, location, duration, starting frame, and the like for the ROs that are available during a timeframe for communication of the preamble during a RACH process. Adaptations to the RACH configuration include the addition of one or more ROs within the timeframe, which may be a repeating timeframe. The adaption may also indicate a change to one or more of the other parameters of the RACH configuration in addition to activating one or more additional ROs.

The PDCCH order may use a downlink control information (DCI) format 1-0 that includes a bit field for indicating activation of the adaptation to the RACH configuration. The DCI format 520 includes a plurality of fields 521-526 which may include one or more reserved bit fields 525 and 526. Reserved bit fields refer to allocations of bits that may not be specified by a current standard or those that are set aside by current standards for non-standard use or for future definition. In certain aspects, one of the reserved bit fields 525 and 526 specified in the DCI or any other (e.g., unused) bit field (e.g., one of the bit fields 521, 522, 523, or 524) specified in the DCI may be utilized for the first indication. An “unused” bit field may be a bit field specified by a technical standard, but is being repurposed in a specific communication. For example, the time domain resource assignment (TDRA) field or another field that may not be used for a particular transmission can be repurposed to operate as the first bit field to communicate the first indication in the PDCCH order. Accordingly, the first indication, which indicates activation of the adaptation, may be specified by one or more bits in the first bit field without increasing the size of the DCI.

In some instances, a second PDCCH order 517 depicted with reference to the second illustrative timeframe 510 may be transmitted by the network entity. The second PDCCH order 517 may be generated and transmitted to deactivate the adaptation of the RACH configuration. The second PDCCH order 517 may utilize the same bit field used for the first indication, but may be configured to include a different bit value or bit sequence that indicates deactivation adaptation instead of activation of adaptation. For example, the bit filed may include one bit having a “1” value to indicate activation of the adaption and the same bit field may include one bit having a “0” value to indicate deactivation of the adaptation. It is understood that other bit values or sequences of one or more bits may be utilized for the first indication and to distinguish between activation and deactivation of the adaptation. Accordingly, any future specified one or more additional ROs, for example, the one or more additional ROs 519 and 521, which would otherwise be the reoccurrence of the one or more additional ROs 513 and 515 from the first period t in the second period t+1, may be deactivated based on the second PDCCH order 517 providing the first indication corresponding to deactivation of the adaptation. However, the one or more ROs 512 and 514 as specified by the non-adapted RACH configuration repeat from the first period t in the second period t+1 depicted as the one or more ROs 516 and 518. Deactivation of the one or more additional ROs (e.g., the one or more additional ROs 519, 521) may cause the device, such as a UE, that receives the second PDCCH order to not communicate during the one or more additional ROs in the future and further may cause the network entity to stop monitoring the one or more additional ROs. However, the one or more ROs, which were specified in the RACH configuration, are not deactivated with the deactivation of the adaptation as these one or more ROs are not additional ROs added for the adaptation.

In some aspects, the PDCCH order may be configured to include a second indication. The second indication, similar to the first indication, may be specified by one or more bits in one or more of the reserved bit fields 525 and 526 or any other (e.g., unused) bit field (e.g., one of the bit fields 521, 522, 523, or 524). The second indication may be utilized to indicate whether the PDCCH order is intended to trigger a RACH response process or merely activate (or deactivate) an adaptation to the RACH configuration. For example, there may be instances where the network entity determines a need to add additional ROs to reduce latency and/or collisions, but does not need to update a timing advance for a UE. In such instances, for example, the PDCCH order may indicate activation (or deactivation) of the adaptation to the RACH configuration with the first indication and in the same PDCCH order indicate whether the PDCCH order is to trigger a RACH response process with the second indication.

The first indication may indicate activation (or deactivation) of one or more different adaptations. For example, the first indication may correspond to a first bit field of the PDCCH order. The bit value or bit sequence within the first bit field may correspond to activation or deactivation of an adaptation. For example, a bit value of “1” may indicate activation of the adaptation, while the bit value of “0” may indicate activation. In certain aspects, the first bit field may include more than one bit. The first bit field may indicate more than just activation or deactivation of the adaptation. For example, the first bit field may be two bits wide, such that a bit value of “01” may indicate activation of a first adaptation, a bit value of “10” may indicate activation of a second adaptation, a bit value of “11” may indicate activation of a third adaptation, and “00” may indicate deactivation of the adaptations (e.g., the first, second, and third adaptation). The first adaptation may correspond to a change in the periodicity of the ROs. The second adaptation may correspond a change in the RACH configuration index. The third adaptation may correspond to a parameter specified in a RRC configuration. The bit value or bit sequence used by the network entity in the first indication may correspond to information predefined in the UE, such that the UE contains specific parameters or actions to take to implement the adaptation to the RACH configuration. Accordingly, the information provided by the first indication may be merely that an adaptation is to be activated (or deactivated) or the first indication may provide more detailed information regarding what type of adaptation is to be activated (or deactivated). An adaptation of the RACH configuration may be a change in the periodicity of the ROs. For example, the RACH configuration may indicate a first periodicity that in part indicated one or more ROs 502, 504, 506 as depicted, for example, in illustrative timeframe 510. By way of example, the one or more ROs 502, 504, 506 may have a periodicity of 160 ms or 80 ms or another interval. The adaptation may indicate that the periodicity of the one or more ROs be scaled by one-half, one-third, or one-quarter, or another scale value. Accordingly, to change the periodicity from the first periodicity to a second periodicity, which is a scaled value, one or more additional ROs 503, 505, 507 may be activated, for example, as illustrated in the first timeframe 500.

In some aspects, the adaption of the RACH configuration may correspond to a change in the RACH configuration index. This first indication may indicate which index the RACH configuration should change to or simply indicate that an adaptation is activated and the network entity and UE may be preconfigured to select and activate the corresponding adaptation. For example, the RACH configuration may indicate a first RACH configuration index that in part indicates the one or more ROs. The adaptation of the RACH configuration may include a change from the first RACH configuration index to a second RACH configuration index. In some aspects, the adaption of the RACH configuration may be based on a parameter specified in a radio resource control (RRC) configuration. For example, the RRC configuration may include a parameter that indicates the scaling value of the periodicity. In some instances, the original periodicity of the PRACH configuration may be 80 ms. The adaptation parameter indicated in the RRC configuration could be a scaling to this periodicity, for example, 0.5. This means that whenever the PRACH configuration is dynamically adapted, the periodicity would change from 80 ms to 40 ms. In certain aspects, the RRC configuration may include an RRC parameter such as “DynamicRACHAdaptation” that is configured to indicate to a UE whether the PDCCH ordered RACH should include the adapted RACH configuration or not. It is understood that these are only a few examples of adaptations to the RACH configuration. Other adaptations that include the activation of one or more additional ROs are also contemplated.

Aspects of a PDCCH ordered adaptation to the RACH configuration that are described herein may be implemented for contention free random access (CFRA) and/or contention based random access (CBRA).

### Aspects Related to Indication of Adaptation to a RACH Configuration Between a Network Entity and UE

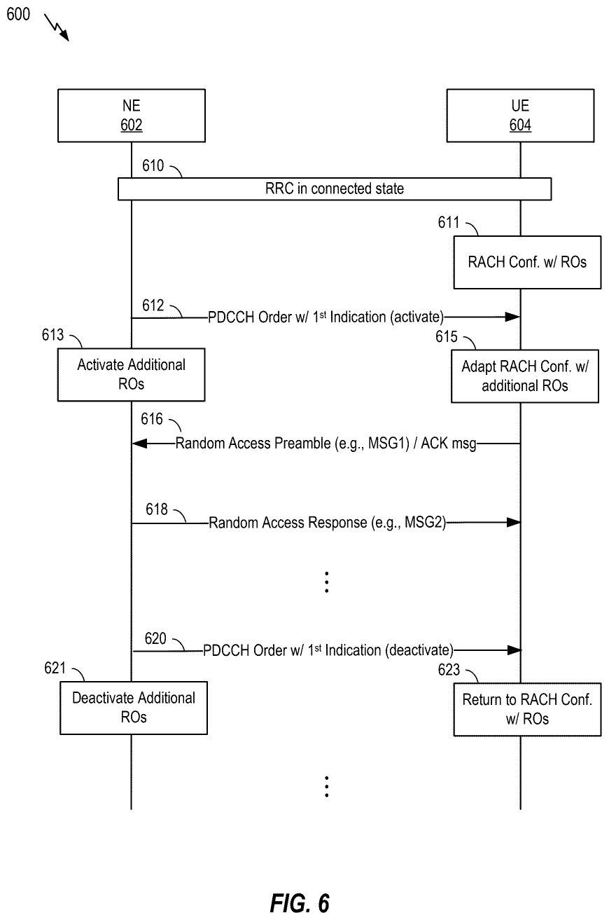

FIG. 6 depicts a process flow 600 for communications in a network between a network entity 602 and a user equipment (UE) 604. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 104 may be another type of wireless communications device and BS 102 may be another type of network entity or network node, such as those described herein.

More specifically, FIG. 6 depicts a process flow 600 of communications between a network entity 602 and a UE 604 related to the network entity 602 providing an indication to adapt a RACH configuration to include one or more additional ROs. The process flow 600 depicted in FIG. 6 corresponds to a CFRA process triggered by a PDCCH order. However, process flow 600 is also applicable to CBRA processes triggered by a PDCCH order. Additionally, while the process flow 600 uses a 4-step RACH process to describe aspects of indicating an adaptation to a RACH configuration, similar adaptations may also apply to a 2-step RACH process. In aspects that utilize the 2-step RACH process, the PUSCH occasions may also be defined with a time and frequency offset from the RACH occasions of the 2-step RACH. It is also noted that the deactivation of the adaptation can occur with the PDCCH ordered RACH or another DCI. The process flow 600 begins with the network entity 602 and UE 604 in an RRC connected state 610. That is, the network entity 602 has established communication with the UE 604, which includes a RACH configuration 611 defining one or more ROs.

At step 612, the network entity transmits, to the UE 604, a PDCCH order comprising a first indication. The first indication indicates activation of an adaptation of the RACH configuration 611 to further include one or more additional ROs. In some aspects, the network entity 602 activates the one or more additional ROs and monitors the one or more ROs and the one or more additional ROs at step 613. In some aspects, the network entity 602 may not begin monitoring the one or more additional ROs until a confirmation signal from the UE 604 is received. For example, the confirmation signal may be a random access preamble (MSG1).

When the UE 604 receives the transmission of the PDCCH order comprising the first indication indicating to activate the adaptation of the RACH configuration, the UE 604 adapts the RACH configuration to further include one or more additional ROs at step 615. The adaptation may include, but is not limited to, a change in the periodicity of ROs from a first periodicity to a second periodicity, a change in the RACH configuration index, an adaption of the RACH configuration based on a parameter specified in the RRC configuration, or other adaptation that includes activation of one or more additional ROs.

As discussed herein, the PDCCH order may include a second indication indicating whether the PDCCH order triggers a RACH response process. Whether the PDCCH order triggers a RACH response process or not, the UE 604 may respond to the network entity with at least a confirmation signal to confirm receipt of the first indication indicating the activation (or deactivation) of the adaptation to the RACH configuration.

The confirmation signal may include the UE 604 transmitting a random access preamble (MSG1) at step 616. However, in other instances, at step 616, the confirmation signal generated and transmitted by the UE 604 may be an acknowledgement (ACK) message based on a PUCCH resource indication (PRI) provided in the PDCCH order.

The following discusses when, in terms of timing, the network entity 602 and/or UE 604 may begin utilizing the one or more additional ROs that are implemented based on activation of the adaptation of the RACH configuration. In certain aspects, the one or more additional ROs may be utilized at the next available time corresponding to the adaptation. For example, one or more additional ROs may begin at the next available time slot corresponding to the adaptation that follows the RO where the preamble or ACK message was sent.

In other instances, there may be a delay or another event, such as the transmission of receipt of a confirmation signal, that needs to occur prior to when the one or more additional ROs may be utilized by the network entity 602 and/or the UE 604. For example, the one or more additional ROs may begin a specified amount of time after the confirmation signal at step 616. In some instances, the delay may correspond to a number of periods or repetitions of a period after the confirmation signal at step 616.

Should the network entity 602 not receive the confirmation signal from the UE 604, for example, within an allotted amount of time, the network entity 602 may return to step 612 and send a second PDCCH order comprising the first indication.

There may be instances where additional communication between the network entity 602 and the UE 604 occurs. For example, at step 618, the network entity 602 may further transmit a random access response (MSG2) to the UE 604. The random access response from the network entity 602 may provide the UE with acknowledgement that the adaptation to the RACH configuration is now established with both the network entity 602 and the UE 604. This acknowledgement may cause the UE 604 to begin utilizing or continue utilizing the one or more additional ROs and the one or more ROs based on the adapted RACH configuration. However, in certain aspects, in a case where the UE 604 does not receive the random access response (MSG2) from the network entity 602 at step 618, then the UE 604 default back to the RACH configuration defining the one or more ROs.

In a related instance, if the UE 604 receives a PDCCH order for a RACH response process from the network entity 602 with an indication to use the non-adapted RACH configuration following an adaptation to the RACH configuration, the UE 604 may be configured to assume one of the following and operate accordingly. First, the UE 604 may carry out the RACH response process using the one or more ROs, thereby reversing any previous adaptation to the RACH configuration. Alternatively, the UE 604 may carry out the RACH response process using the one or more ROs, but maintain the adaptation of the RACH configuration for future communication. That is, the UE 604 may continue to consider the one or more additional ROs as valid ROs, but use the one or more ROs corresponding to the non-adapted RACH configuration.

The following instances relate to the timeline, for example, how long an adaptation of the RACH configuration should be considered valid by the UE 604. Following adaption of the RACH configuration based on a PDCCH order comprising the first indication indicating to activate the adaptation of the RACH configuration, the UE 604 may be configured to operate with the adapted RACH configuration until another PDCCH order having a further indication to activate another adaptation or deactivate the adaptation is received from the network entity 602. For example, at step 620 the network entity 602 may transmit a second PDCCH order where the first indication indicated deactivation of the adaptation to the RACH configuration. Accordingly, at step 621, the network entity 602 may deactivate the one or more additional ROs and stop monitoring the one or more additional ROs for receptions, thereby enabling to the network entity 602 to optionally implement energy saving processes such as entering a sleep state. The UE 604, based on the second PDCCH order having the first indication that indicates deactivation of the adaptation to the RACH configuration, may return to the non-adapted RACH configuration with only the one or more ROs at step 623. Alternatively, the UE 604 may be configured to only utilize the adapted RACH configuration until a successful RACH process is completed. At that time, the UE 604 may return to the non-adapted RACH configuration with only the one or more ROs at step 623. Although not depicted in detail, the deactivation of the adaptation to the RACH configuration based on the second PDCCH order may further include a confirmation signal from the UE 604 to the network entity 602 and a subsequent acknowledgement signal from the network entity 602 to the UE 604 as discussed with reference to steps 616 and 618.

### Example Methods for Adaptation of A RACH Configuration

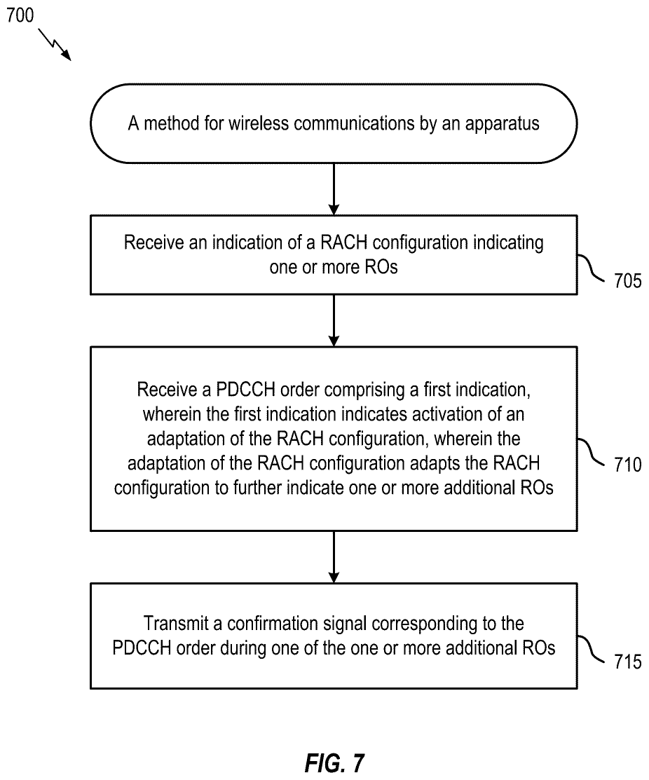

FIG. 7 shows a method 700 for wireless communications by an apparatus, such as UE 104 of FIGS. 1 and 3 or UE 604 as discussed with reference to FIG. 6. For example, the apparatus may adapt a RACH configuration based on an indication received, for example, from a network entity. Adaptation of the RACH configuration may enable the apparatus to communicate with the network entity during one or more additional ROs such that latency and/or collisions in communication with the network entity may be reduced.

Method 700 begins at block 705 with receiving an indication of a RACH configuration indicating one or more ROs. For example, block 705 may correspond to the RACH configuration 611 established between the network entity 602 and UE 604 as discussed with reference to FIG. 6.

Method 700 then proceeds to block 710 with receiving a PDCCH order comprising a first indication, wherein the first indication indicates activation of an adaptation of the RACH configuration, wherein the adaptation of the RACH configuration adapts the RACH configuration to further indicate one or more additional ROs. For example, block 710 may correspond to step 612 as discussed with reference to FIG. 6.

Method 700 then proceeds to block 715 with transmitting a confirmation signal corresponding to the PDCCH order during one of the one or more additional ROs. For example, block 715 may correspond to step 616 as discussed with reference to FIG. 6. The confirmation signal may be a preamble, an ACK message, or other signal indicating confirmation of the adaptation of the RACH configuration that the UE provides the network entity.

In one aspect, the first indication is specified by one or more bits in a first bitfield of the PDCCH order.

In one aspect, the PDCCH order further comprises a second indication, wherein the second indication indicates whether the PDCCH order triggers a RACH response process.

In one aspect, the second indication is specified by one or more bits in a second bitfield of the PDCCH order.

In one aspect, the RACH configuration indicates a first periodicity that in part indicates the one or more ROs, and wherein the adaptation of the RACH configuration comprises a change from the first periodicity to a second periodicity.

In one aspect, the RACH configuration indicates a first RACH configuration index that in part indicates the one or more ROs, wherein the adaptation of the RACH configuration comprises a change from the first RACH configuration index to a second RACH configuration index.

In one aspect, the adaptation of the RACH configuration is based on a parameter specified in a RRC configuration.

In one aspect, the confirmation signal comprises a CFRA preamble.

In one aspect, the confirmation signal comprises an ACK message based on a PRI provided in the PDCCH order.

In one aspect, method 700 further includes transmitting a confirmation signal of the PDCCH order.

In one aspect, method 700 further includes receiving a random access response based on the confirmation signal.

In one aspect, method 700 further includes deactivating the adaptation of the RACH configuration.

In one aspect, method 700 further includes receiving a second PDCCH order comprising the first indication, wherein the first indication indicates deactivation of the adaptation of the RACH configuration.

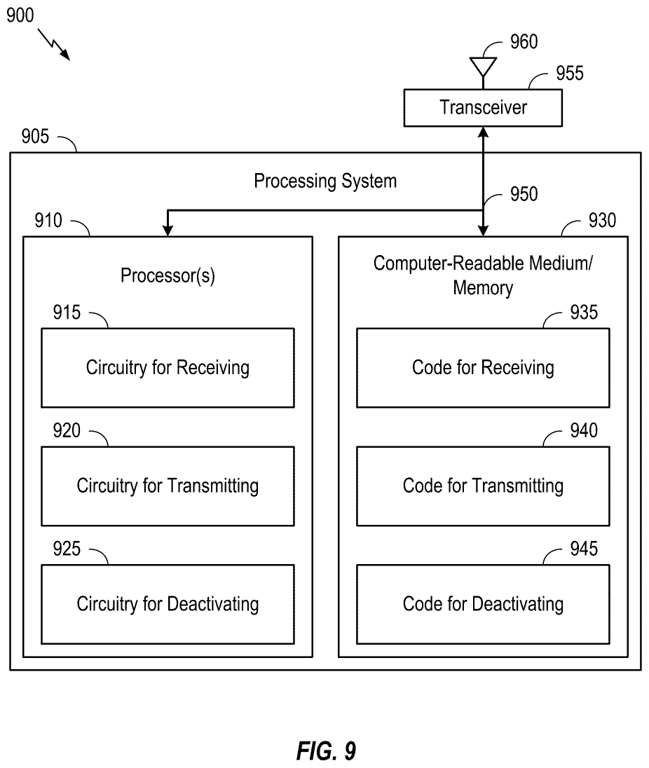

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

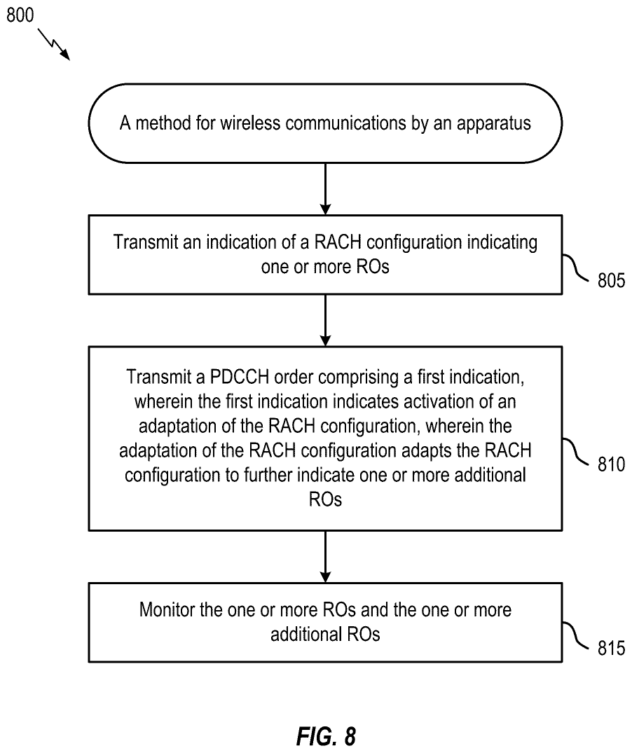

FIG. 8 shows a method 800 for wireless communications by an apparatus, such as a BS 102 of FIGS. 1 and 3, a disaggregated base station as discussed with respect to FIG. 2, or network entity 602 as discussed with reference to FIG. 6. For example, the apparatus may adapt a RACH configuration to include one or more additional RACH configurations for communication with a UE, for example. Adaptation of the RACH configuration may enable the apparatus to communicate with the UE during one or more additional ROs such that latency and/or collisions in communication with the UE may be reduced. Furthermore, since the adaptation may be selectively and dynamically activated and deactivated for specified intervals, the apparatus may continue to employ energy saving techniques when the adaptation of the RACH configuration is not activated.

Method 800 begins at block 805 with transmitting an indication of a RACH configuration indicating one or more ROs. For example, block 805 may correspond to the RACH configuration 611 established between the network entity 602 and UE 604 as discussed with reference to FIG. 6.

Method 800 then proceeds to block 810 with transmitting a PDCCH order comprising a first indication, wherein the first indication indicates activation of an adaptation of the RACH configuration, wherein the adaptation of the RACH configuration adapts the RACH configuration to further indicate one or more additional ROs. For example, block 810 may correspond to step 612 as discussed with reference to FIG. 6.

Method 800 then proceeds to block 815 with monitoring the one or more ROs and the one or more additional ROs. For example, block 815 may correspond to step 613 as discussed with reference to FIG. 6.

In certain aspects, method 800 further includes receiving a confirmation signal corresponding to the PDCCH order; and block 815 includes monitoring the one or more additional ROs based on the confirmation signal.

In one aspect, the first indication is specified by one or more bits in a first bitfield of the PDCCH order.

In one aspect, the PDCCH order further comprises a second indication, wherein the second indication indicates whether the PDCCH order triggers a RACH response process.

In one aspect, the second indication is specified by one or more bits in a second bitfield of the PDCCH order.

In one aspect, the RACH configuration indicates a first periodicity that in part indicates the one or more ROs, and wherein the adaptation of the RACH configuration comprises a change from the first periodicity to a second periodicity.

In one aspect, the RACH configuration indicates a first RACH configuration index that in part indicates the one or more ROs, wherein the adaptation of the RACH configuration comprises a change from the first RACH configuration index to a second RACH configuration index.

In one aspect, the adaptation of the RACH configuration is based on a parameter specified in a RRC configuration.

In certain aspects, method 800 further includes receiving a confirmation signal corresponding to the PDCCH order; and the confirmation signal comprises a CFRA preamble.

In certain aspects, method 800 further includes receiving a confirmation signal corresponding to the PDCCH order; and the confirmation signal comprises an ACK message based on a PRI provided in the PDCCH order.

In certain aspects, method 800 further includes transmitting another PDCCH order comprising the first indication based on a failure to receive a confirmation signal of the PDCCH order.

In certain aspects, method 800 further includes receiving a confirmation signal corresponding to the PDCCH order, wherein the confirmation signal is received during at least one of the one or more additional ROs.

In certain aspects, method 800 further includes receiving a confirmation signal of the PDCCH order.

In certain aspects, method 800 further includes transmitting a random access response based on the confirmation signal.

In certain aspects, method 800 further includes deactivating the adaptation of the RACH configuration.

In certain aspects, method 800 further includes receiving a confirmation signal of the PDCCH order.

In certain aspects, method 800 further includes transmitting a second PDCCH order comprising the first indication, wherein the first indication indicates deactivation of the adaptation of the RACH configuration.

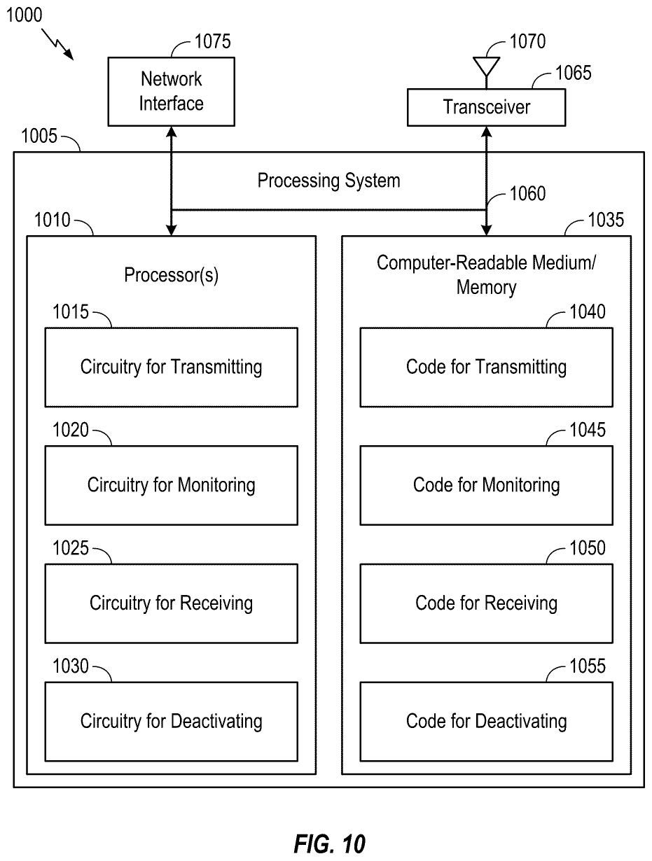

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900. In some aspects, communications device 900 is a user equipment, such as UE 104 described above with respect to FIGS. 1 and 3 or UE 604 as discussed with respect to FIG. 6.

The communications device 900 includes a processing system 905 coupled to a transceiver 955 (e.g., a transmitter and/or a receiver). The transceiver 955 is configured to transmit and receive signals for the communications device 900 via an antenna 960, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 930 via a bus 950. In certain aspects, the computer-readable medium/memory 930 is configured to store instructions (e.g., computer-executable code), including code 935-945, that when executed by the one or more processors 910, enable and cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 930 stores code for receiving 935, code for transmitting 940, and code for deactivating 945. Processing of the code 935-945 may enable and cause the communications device 900 to perform the method 700 described with respect to FIG. 7, or any aspect related to it.

The one or more processors 910 include circuitry configured to implement (e.g., execute) the code (e.g., executable instructions) stored in the computer-readable medium/memory 930, including circuitry for receiving 915, circuitry for transmitting 920, and circuitry for deactivating 925. Processing with circuitry 915-925 may enable and cause the communications device 900 to perform the method 700 described with respect to FIG. 7, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 955 and/or antenna 960 of the communications device 900 in FIG. 9, and/or one or more processors 910 of the communications device 900 in FIG. 9. Means for communicating, receiving or obtaining may include the transceivers 354, antenna(s) 352, receive processor 358, AI processor 370, and/or controller/processor 380 of the UE 104 illustrated in FIG. 3, transceiver 955 and/or antenna 960 of the communications device 900 in FIG. 9, and/or one or more processors 910 of the communications device 900 in FIG. 9.

FIG. 10 depicts aspects of an example communications device 1000. In some aspects, communications device 1000 is a network entity, such as BS 102 of FIGS. 1 and 3, a disaggregated base station as discussed with respect to FIG. 2, or a network entity 602 as discussed with respect to FIG. 6.

The communications device 1000 includes a processing system 1005 coupled to a transceiver 1065 (e.g., a transmitter and/or a receiver) and/or a network interface 1075. The transceiver 1065 is configured to transmit and receive signals for the communications device 1000 via an antenna 1070, such as the various signals as described herein. The network interface 1075 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1035 via a bus 1060. In certain aspects, the computer-readable medium/memory 1035 is configured to store instructions (e.g., computer-executable code), including code 1040-1055, that when executed by the one or more processors 1010, enable and cause the one or more processors 1010 to perform the method 800 described with respect to FIG. 8, or any aspect related to it, including any operations described in relation to FIG. 8. Note that reference to a processor of communications device 1000 performing a function may include one or more processors of communications device 1000 performing that function, such as in a distributed fashion.

In the depicted example, the computer-readable medium/memory 1035 stores code for transmitting 1040, code for monitoring 1045, code for receiving 1050, and code for deactivating 1055. Processing of the code 1040-1055 may enable and cause the communications device 1000 to perform the method 800 described with respect to FIG. 8, or any aspect related to it.

The one or more processors 1010 include circuitry configured to implement (e.g., execute) the code (e.g., executable instructions) stored in the computer-readable medium/memory 1035, including circuitry for transmitting 1015, circuitry for monitoring 1020, circuitry for receiving 1025, and circuitry for deactivating 1030. Processing with circuitry 1015-1030 may enable and cause the communications device 1000 to perform the method 800 described with respect to FIG. 8, or any aspect related to it.

Various components of the communications device 1000 may provide means for performing the method 800 described with respect to FIG. 8, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1065, antenna 1070, and/or network interface 1075 of the communications device 1000 in FIG. 10, and/or one or more processors 1010 of the communications device 1000 in FIG. 10. Means for communicating, receiving or obtaining may include the transceivers 332, antenna(s) 334, receive processor 338, AI processor 318, and/or controller/processor 340 of the BS 102 illustrated in FIG. 3, transceiver 1065, antenna 1070, and/or network interface 1075 of the communications device 1000 in FIG. 10, and/or one or more processors 1010 of the communications device 1000 in FIG. 10.

### Example Clauses

Implementation examples are described in the following numbered clauses:

Clause 1: A method for wireless communications by an apparatus comprising: transmitting an indication of a RACH configuration indicating one or more ROs; transmitting a PDCCH order comprising a first indication, wherein the first indication indicates activation of an adaptation of the RACH configuration to further indicate one or more additional ROs; and monitoring the one or more ROs and the one or more additional ROs.

Clause 2: The method of Clause 1, further comprising receiving a confirmation signal corresponding to the PDCCH order; and monitoring the one or more additional ROs comprises monitoring the one or more additional ROs based on the confirmation signal.

Clause 3: The method of any one of Clauses 1-2, wherein the first indication is specified by one or more bits in a first bitfield of the PDCCH order.

Clause 4: The method of any one of Clauses 1-3, wherein the PDCCH order further comprises a second indication, wherein the second indication indicates whether the PDCCH order triggers a RACH response process.

Clause 5: The method of Clause 4, wherein the second indication is specified by one or more bits in a second bitfield of the PDCCH order.

Clause 6: The method of any one of Clauses 1-5, wherein the RACH configuration indicates a first periodicity that in part indicates the one or more ROs, and wherein the adaptation of the RACH configuration comprises a change from the first periodicity to a second periodicity.

Clause 7: The method of any one of Clauses 1-6, wherein the RACH configuration indicates a first RACH configuration index that in part indicates the one or more ROs, wherein the adaptation of the RACH configuration comprises a change from the first RACH configuration index to a second RACH configuration index.

Clause 8: The method of any one of Clauses 1-7, wherein the adaptation of the RACH configuration is based on a parameter specified in a RRC configuration.

Clause 9: The method of any one of Clauses 1-8, further comprising receiving a confirmation signal corresponding to the PDCCH order; and the confirmation signal comprises a CFRA preamble.

Clause 10: The method of any one of Clauses 1-9, further comprising receiving a confirmation signal corresponding to the PDCCH order; and the confirmation signal comprises an ACK message based on a PRI provided in the PDCCH order.

Clause 11: The method of any one of Clauses 1-10, further comprising transmitting another PDCCH order comprising the first indication based on a failure to receive a confirmation signal of the PDCCH order.

Clause 12: The method of any one of Clauses 1-11, further comprising receiving a confirmation signal corresponding to the PDCCH order, wherein the confirmation signal is received during at least one of the one or more additional ROs.

Clause 13: The method of any one of Clauses 1-12, further comprising: receiving a confirmation signal of the PDCCH order; transmitting a random access response based on the confirmation signal; and deactivating the adaptation of the RACH configuration.

Clause 14: The method of any one of Clauses 1-13, further comprising: receiving a confirmation signal of the PDCCH order; and transmitting a second PDCCH order comprising the first indication, wherein the first indication indicates deactivation of the adaptation of the RACH configuration.

Clause 15: A method for wireless communications by an apparatus comprising: receiving an indication of a RACH configuration indicating one or more ROs; receiving a PDCCH order comprising a first indication, wherein the first indication indicates activation of an adaptation of the RACH configuration, wherein the adaptation of the RACH configuration adapts the RACH configuration to further indicate one or more additional ROs; and transmitting a confirmation signal corresponding to the PDCCH order during one of the one or more additional ROs.

Clause 16: The method of Clause 15, wherein the first indication is specified by one or more bits in a first bitfield of the PDCCH order.

Clause 17: The method of any one of Clauses 15-16, wherein the PDCCH order further comprises a second indication, wherein the second indication indicates whether the PDCCH order triggers a RACH response process.

Clause 18: The method of Clause 17, wherein the second indication is specified by one or more bits in a second bitfield of the PDCCH order.

Clause 19: The method of any one of Clauses 15-18, wherein the RACH configuration indicates a first periodicity that in part indicates the one or more ROs, and wherein the adaptation of the RACH configuration comprises a change from the first periodicity to a second periodicity.

Clause 20: The method of any one of Clauses 15-19, wherein the RACH configuration indicates a first RACH configuration index that in part indicates the one or more ROs, wherein the adaptation of the RACH configuration comprises a change from the first RACH configuration index to a second RACH configuration index.

Clause 21: The method of any one of Clauses 15-20, wherein the adaptation of the RACH configuration is based on a parameter specified in a RRC configuration.

Clause 22: The method of any one of Clauses 15-21, wherein the confirmation signal comprises a CFRA preamble.

Clause 23: The method of any one of Clauses 15-22, wherein the confirmation signal comprises an ACK message based on a PRI provided in the PDCCH order.

Clause 24: The method of any one of Clauses 15-23, further comprising: receiving a random access response based on the confirmation signal; and deactivating the adaptation of the RACH configuration.

Clause 25: The method of any one of Clauses 15-24, further comprising receiving a second PDCCH order comprising the first indication, wherein the first indication indicates deactivation of the adaptation of the RACH configuration.

Clause 26: One or more apparatuses, comprising: one or more memories comprising executable instructions; and one or more processors configured to execute the executable instructions and cause the one or more apparatuses to perform a method in accordance with any one of Clauses 1-25.

Clause 27: One or more apparatuses, comprising: one or more memories; and one or more processors, coupled to the one or more memories, configured to cause the one or more apparatuses to perform a method in accordance with any one of Clauses 1-25.

Clause 28: One or more apparatuses, comprising: one or more memories; and one or more processors, coupled to the one or more memories, configured to perform a method in accordance with any one of Clauses 1-25.

Clause 29: One or more apparatuses, comprising means for performing a method in accordance with any one of Clauses 1-25.

Clause 30: One or more non-transitory computer-readable media comprising executable instructions that, when executed by one or more processors of one or more apparatuses, cause the one or more apparatuses to perform a method in accordance with any one of Clauses 1-25.

Clause 31: One or more computer program products embodied on one or more computer-readable storage media comprising code for performing a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories; and one or more processors coupled to the one or more memories and configured to cause the apparatus to:
transmit an indication of a random access channel (RACH) configuration indicating one or more RACH occasions (ROs);
transmit a physical downlink control channel (PDCCH) order comprising a first indication, wherein the first indication indicates activation of an adaptation of the RACH configuration, wherein the adaptation of the RACH configuration adapts the RACH configuration to further indicate one or more additional ROs; and
monitor the one or more ROs and the one or more additional ROs.

2. The apparatus of claim 1, wherein:
the one or more processors are configured to further cause the apparatus to receive a confirmation signal corresponding to the PDCCH order; and
to monitor the one or more additional ROs, the one or more processors are configured to cause the apparatus to monitor the one or more additional ROs based on the confirmation signal.

3. The apparatus of claim 1, wherein the first indication is specified by one or more bits in a first bitfield of the PDCCH order.

4. The apparatus of claim 1, wherein the PDCCH order further comprises a second indication, wherein the second indication indicates whether the PDCCH order triggers a RACH response process.

5. The apparatus of claim 4, wherein the second indication is specified by one or more bits in a second bitfield of the PDCCH order.

6. The apparatus of claim 1, wherein the RACH configuration indicates a first periodicity that in part indicates the one or more ROs, and wherein the adaptation of the RACH configuration comprises a change from the first periodicity to a second periodicity.

7. The apparatus of claim 1, wherein the RACH configuration indicates a first RACH configuration index that in part indicates the one or more ROs, wherein the adaptation of the RACH configuration comprises a change from the first RACH configuration index to a second RACH configuration index.

8. The apparatus of claim 1, wherein the adaptation of the RACH configuration is based on a parameter specified in a radio resource control (RRC) configuration.

9. The apparatus of claim 1, wherein:
the one or more processors are configured to further cause the apparatus to receive a confirmation signal corresponding to the PDCCH order; and
the confirmation signal comprises a contention free random access (CFRA) preamble.

10. The apparatus of claim 1, wherein:
the one or more processors are configured to further cause the apparatus to receive a confirmation signal corresponding to the PDCCH order; and
the confirmation signal comprises an acknowledgement (ACK) message based on a physical uplink control channel (PUCCH) resource indication (PRI) provided in the PDCCH order.

11. The apparatus of claim 1, wherein the one or more processors are configured to further cause the apparatus to transmit another PDCCH order comprising the first indication based on a failure to receive a confirmation signal of the PDCCH order.

12. The apparatus of claim 1, wherein the one or more processors are configured to further cause the apparatus to receive a confirmation signal corresponding to the PDCCH order, wherein the confirmation signal is received during at least one of the one or more additional ROs.

13. The apparatus of claim 1, wherein the one or more processors are configured to further cause the apparatus to:
receive a confirmation signal of the PDCCH order;
transmit a random access response based on the confirmation signal; and
deactivate the adaptation of the RACH configuration.

14. The apparatus of claim 1, wherein the one or more processors are configured to further cause the apparatus to:
receive a confirmation signal of the PDCCH order; and
transmit a second PDCCH order comprising the first indication, wherein the first indication indicates deactivation of the adaptation of the RACH configuration.

15. An apparatus configured for wireless communications, comprising: one or more memories; and one or more processors coupled to the one or more memories and configured to cause the apparatus to:
receive an indication of a random access channel (RACH) configuration indicating one or more RACH occasions (ROs);
receive a physical downlink control channel (PDCCH) order comprising a first indication, wherein the first indication indicates activation of an adaptation of the RACH configuration, wherein the adaptation of the RACH configuration adapts the RACH configuration to further indicate one or more additional ROs; and
transmit a confirmation signal corresponding to the PDCCH order during one of the one or more additional ROs.

16. The apparatus of claim 15, wherein the PDCCH order further comprises a second indication, wherein the second indication indicates whether the PDCCH order triggers a RACH response process.

17. The apparatus of claim 15, wherein the confirmation signal comprises a contention free random access (CFRA) preamble.

18. The apparatus of claim 15, wherein the confirmation signal comprises an acknowledgement (ACK) message based on a physical uplink control channel (PUCCH) resource indication (PRI) provided in the PDCCH order.

19. The apparatus of claim 15, wherein the one or more processors are configured to further cause the apparatus to receive a second PDCCH order comprising the first indication, wherein the first indication indicates deactivation of the adaptation of the RACH configuration.

20. A method for wireless communications by an apparatus comprising:
transmitting an indication of a random access channel (RACH) configuration indicating one or more RACH occasions (ROs);
transmitting a physical downlink control channel (PDCCH) order comprising a first indication, wherein the first indication indicates activation of an adaptation of the RACH configuration to further indicate one or more additional ROs; and
monitoring the one or more ROs and the one or more additional ROs.
